(19) United States
(12) Patent Application Publication
(10) Pub. No.: US 2004/0249102 A1
(43) Pub. Date: Dec. 9, 2004

(54) Low shrinkback hotmelt PSA, its preparation and use

(75) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 10/800,341

(22) Filed: Mar. 12, 2004

(30) Foreign Application Priority Data
Mar. 18, 2003 (DE) 103 12 062.9

(51) Int. Cl. B32B 27/08

(52) U.S. Cl. 526/935; 428/515; 523/118

(57) ABSTRACT

The invention relates to a hotmelt pressure sensitive adhesive (PSA), in particular an acrylic hotmelt PSA, featuring low shrinkback after extrusion coating, to a process for preparing it, and to its use for producing PSA tapes.

The hotmelt pressure sensitive adhesive of the invention comprises at least one polyacrylate component and added filler comprising calcium carbonate, preferably taking the form of chalk. Said at least one polyacrylate component

is based, with a mass fraction of at least 50% by weight, on at least one acrylic and/or methacrylic ester of the general formula (I)

CH₂═CH(R₁)(COOR₂), (I)

where R₁═H or CH₃ and R₂ is an unbranched, branched or cyclic alkyl radical having 1 to 22 carbon atoms and

is substantially free from polar groups, especially carboxylic acid or hydroxyl groups.

The invention relates to a hotmelt pressure sensitive adhesive (PSA), in particular an acrylic hotmelt PSA, featuring low shrinkback after extrusion coating, to a process for preparing it, and to its use for producing PSA tapes.

For industrial PSA tape applications it is very common to use polyacrylate PSAs. Polyacrylates possess a variety of advantages over other elastomers. They are highly stable toward UV light, oxygen, and ozone. Synthetic and natural rubber adhesives normally contain double bonds, which make these adhesives unstable to the aforementioned environmental effects. Another advantage of polyacrylates is their serviceability over a relatively wide temperature range.

Polyacrylate PSAs are generally prepared in solution by free radical polymerization. The polyacrylates are generally applied to the corresponding backing material from solution using a coating bar and then dried. In order to increase the cohesion the polymer is normally crosslinked. This curing takes place thermally or by UV crosslinking or by EB (electron beam) curing. The operation described is fairly costly and environmentally objectionable, since as a general rule the solvent does not recycle and the high consumption of organic solvents represents a high environmental burden. It is also very difficult to produce PSA tapes with a high adhesive application rate without bubbles.

One remedy to these disadvantages is the hotmelt process. In this process the PSA is applied to the backing material from the melt.

This new technology, however, is not without its limitations. Prior to coating, the solvent must be removed from the PSA in a drying extruder. The drying operation is associated with relatively high temperature and shearing, so that high molecular mass polyacylate PSAs in particular are severely damaged. The acrylic PSA gels, or there is a sharp increase in the low molecular mass fraction as a result of molecular weight breakdown. Both effects are undesirable, since they are disadvantageous for the application. Either the adhesive can no longer be applied or there are changes in its technical adhesive properties, since, for example, when a shearing force acts on the adhesive the low molecular mass fractions act as lubricants and so lead to premature failure of the adhesive.

The reduced shear strength is difficult to compensate. One option is to raise the polarity, by means of increased fractions of acrylic acid, for example. This path, however, results in an increase not only in the shear strength but also in the glass transition temperature. With very large amounts of acrylic acid, the polymer undergoes embrittlement and there are distinct falls in the bond strength and tack.

Another possibility is to increase the crosslinking of the hotmelt PSA. In this case the composition becomes more highly crosslinked (increased gel value) and there is an increase in the rigidity of the system and hence also in the shear strength. Here again, a disadvantage is the lacquering which occurs with high degrees of crosslinking.

A further option for raising the cohesion is to add fillers, which in turn cause the cohesion to rise as a result of interactions with the hotmelt PSA. In this case as well, in analogy to the problem of the increasing acrylic acid fractions in the polyacrylate hotmelt PSA, there is a distinct fall in bond strength.

A further disadvantage of acrylic hotmelt PSAs is the orientation which occurs after extrusion coating. During the coating operation the hotmelt adhesive is forced through a die and then, as it is transferred to the backing material, is stretched once again. This produces an orientation of the polymer chains, which then, on the backing material, move back to the original unordered state (fundamental thermodynamic principle of the increase in entropy). This is manifested visually in so-called shrinkback of the PSA, which can indeed be desirable in certain cases but is unusual in comparison with conventional solvent coating.

The measures already mentioned for raising the polarity or adding fillers are in this case likewise counterproductive, since the interactions described also result in an increase in the orientation.

There is therefore a need for an acrylic hotmelt PSA which does not have the above-mentioned disadvantages and which therefore exhibits not only a high shear strength and high bond strengths even on nonpolar surfaces but also a very low shrinkback after extrusion coating.

This object is achieved by a hotmelt pressure sensitive adhesive having a specific composition.

The hotmelt pressure sensitive adhesive of the invention comprises at least one polyacrylate component and added filler comprising calcium carbonate, preferably taking the form of chalk. Said at least one polyacrylate component

is based, with a mass fraction of at least 50% by weight, on at least one acrylic and/or methacrylic ester of the general formula (I)

CH₂═CH(R₁)(COOR₂), (I)

where R₁═H or CH₃ and R₂ is an unbranched, branched or cyclic alkyl radical having 1 to 22 carbon atoms and

is substantially free from polar groups, especially carboxylic acid or hydroxyl groups.

Further subclaims relate to advantageous further developments.

The hotmelt PSA of the invention exhibits a shrinkback after extrusion coating (measured by test method A, shrinkback measurement in the free film, see below) of not more than 5%, in particular not more than 4%, especially not more than 3%.

It has proven particularly advantageous if the polyacrylates of the polyacrylate component have an average molar mass M_{w} of not more than 500 000 g/mol, in particular not more than 450 000 g/mol, very preferably not more than 400 000 g/mol.

Furthermore, the added filler comprising calcium carbonate preferably has a mass fraction, based on the polyacrylate component, of at least 10% by weight, in particular at least 15% by weight. With these preferred fractions there is virtually no change in the technical adhesive properties (RT shear strength, instantaneous bond strength on steel and PE) as a result of the added filler. A variety of forms of chalk can be used here, particular preference being given to the use of Mikrosöhl chalk (from Söhlde).

Oriented PSAs are understood below to be those exhibiting a tendency, after stretching in a given direction, to move back into the initial state as a result of what is termed their entropy-elastic behavior.

The monomers are preferably chosen such that the resulting polymers can be used, at room temperature or above, as pressure sensitive adhesives, particularly such that the resulting polymers possess pressure sensitive adhesion properties in accordance with the “Handbook of Pressure Sensitive Adhesive Technology” by Donatas Satas (van Nostrand, N.Y. 1989).

With great preference the acrylate and/or methacrylate monomers used are those comprising acrylic or methacrylic esters with alkyl groups having 4 to 14 carbon atoms, preferably 4 to 9 carbon atoms. Specific examples, without wishing to impose any restriction by this enumeration, include methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are (meth)acrylates with bridged cycloalkyl radicals having at least 6 carbon atoms. The cycloalkyl alcohols can also be substituted, by C₁ to C₆ alkyl groups, halide groups or cyano groups or the like, for example. Specific examples include cyclohexyl methacrylates, isobornyl acrylate, isobornyl methacrylates, and 3,5-dimethyladamantyl acrylate.

In one particularly advantageous embodiment of the invention said at least one polyacrylate component is based on at least one comonomer in addition to said at least one acrylic and/or methacrylic ester.

As further monomers it is possible in particular to make use, inter alia, of moderately basic monomers including singly or doubly N-alkyl-substituted amides, especially acrylamides, examples being N,N-dimethylacrylamide, N,N-dimethylmethacrylamide, N-tert-butylacrylamide, N-vinylpyrrolidone, N-vinyllactam, dimethylaminoethyl acrylate, dimethylaminoethyl methacrylate, diethylaminoethyl acrylate, diethylaminoethyl methacrylate, N-methylolacrylamide, N-methylolmethacrylamide, N-(butoxymethyl)-methacrylamide, N-(ethoxymethyl)acrylamide, and N-isopropylacrylamide, without this enumeration being exhaustive.

Further examples of suitable comonomers are maleic anhydride, itaconic anhydride, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, and tetrahydrofurfuryl acrlyate, without this enumeration being exhaustive.

In another very preferred procedure the comonomers used are vinyl esters, vinyl ethers, vinyl halides, vinylidene halides, and vinyl compounds having aromatic rings and heterocycles in α-position. Here again, mention may be made nonexclusively of some examples: vinyl acetate, vinyl formamide, vinyl pyridine, ethyl vinyl ether, vinyl chloride, vinylidene chloride, and acrylonitrile.

Moreover, in a further procedure, use is made optionally, as comonomers, of photo-initiators having copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free radical mechanism under UV irradiation. An overview of possible photoinitiators for use, which can be functionalized with a double bond, is given in Fouassier: “Photoinitiation, Photopolymerization and Photocuring: Fundamentals and Applications”, Hanser-Verlag, Munich 1995. For further details recourse can be had to Carroy et al. in “Chemistry and Technology of UV and EB Formulation for Coatings, Inks and Paints”, Oldring (ed.), 1994, SITA, London.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxy-styrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

For further development it is possible to admix resins to the PSAs of the invention. As tackifying resins for addition it is possible without exception to use all existing tackifier resins and those described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C₅, C₉, and other hydro-carbon resins. Any desired combinations of these and further resins may be used in order to adjust the properties of the resultant adhesive in accordance with requirements.

Generally speaking it is possible to employ any resins which are compatible (soluble) with the polyacrylate in question: in particular, reference may be made to all aliphatic, aromatic, and alkylaromatic hydrocarbon resins, hydrocarbon resins based on single monomers, hydrogenated hydrocarbon resins, functional hydrocarbon resins, and natural resins. Express reference may be made to the depiction of the state of the art in the “Handbook of Pressure Sensitive Adhesive Technology” by Donatas Satas (van Nostrand, 1989).

In addition it is possible optionally to add plasticizers, nucleators, expandants, compounding agents and/or aging inhibitors, in the form for example of primary and secondary antioxidants or in the form of light stabilizers.

In addition it is possible to admix crosslinkers and crosslinking promoters. Examples of suitable crosslinkers for electron beam crosslinking and UV crosslinking include difunctional or polyfunctional acrylates, difunctional or polyfunctional isocyanates (including those in block form), and difunctional or polyfunctional epoxides.

For optional though not preferred crosslinking with UV light it is possible to add UV-absorbing photoinitiators to the polyacrylate PSAs. Useful photoinitiators whose use is very effective are benzoin ethers, such as benzoin methyl ether and benzoin isopropyl ether, substituted acetophonones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxy-propiophenone, aromatic sulfonyl chlorides, such as 2-naphthylsulfonyl chloride, and photoactive oximes, such as 1-phenyl-1,2-propanedione 2-(O-ethoxycarbonyl) oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. For further details it is possible to consult Carroy et al. in “Chemistry and Technology of UV and EB Formulation for Coatings, Inks and Paints”, Oldring (ed.), 1994, SITA, London.

Preparation Processes for the Inventive PSAs

In accordance with the process of the invention for preparing the hotmelt PSA

(a) at least one polyacrylate component is prepared by at least partial polymerization of at least one acrylic and/or methacrylic ester of the general formula CH₂═CH(R₁)(COOR₂) with the above definitions, in the presence if desired of at least one comonomer, and

(b) before or after the polymerization a filler comprising calcium carbonate is admixed.

For the polymerization the monomers are chosen such that the resultant polymers can be used at room or higher temperatures as PSAs, particularly such that the resulting polymers possess pressure sensitive adhesion properties in accordance with the “Handbook of Pressure Sensitive Adhesive Technology” by Donatas Satas (van Nostrand, N.Y. 1989). In order to achieve a preferred polymer glass transition temperature T_{G} of ≦25° C. it is very preferred, in accordance with the comments made above, to select the monomers, and choose the quantitative composition of the monomer mixture, so as to result in the desired T_{G} for the polymer in accordance with the Fox equation (G1) (cf. T. G. Fox, Bull. Am. Phys. Soc. 1 (1956) 123).

$$\frac{1}{{T}_{G}} = {\sum }_{n} \frac{{w}_{n}}{{T}_{G , n}} \qquad ( G1 )$$

In this equation, n represents the serial number of the monomers used, wₙ the mass fraction of the respective monomer n (% by weight) and T_{G,n} the respective glass transition temperature of the homopolymer of the respective monomer n, in kelvins.

For the preparation of the poly(meth)acrylate component it is advantageous to carry out conventional free radical polymerizations with the monomers, in the presence of the comonomers where appropriate. For the polymerizations, which preferably proceed by a free-radical mechanism with photoinitiation, it is preferred to employ initiator systems which also contain further free radical initiators for the polymerization, especially thermally decomposing, radical-forming azo or peroxo initiators. In principle, however, all customary initiators which are familiar to the skilled worker for acrylates are suitable. The production of C-centered radicals is described in Houben Weyl (Methoden der Organischen Chemie, Vol. E 19a, pp. 60-147). These methods are employed, preferentially, in analogy.

Examples of free radical sources are peroxides, hydroperoxides, and azo compounds; some nonlimiting examples of typical free radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free radical initiator used is 1,1′-azobis(cyclohexane-carbonitrile) (Vazo 88™ from DuPont) or azodiisobutyronitrile (AIBN).

The filler comprising CaCO₃, especially chalk, can be admixed to the monomers before the polymerization and/or after the end of the polymerization.

The average molecular weights M_{w} of the PSAs formed in the free radical polymerization are very preferably chosen such that they are situated within a range M_{w} of <400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are straight alkanes (e.g. hexane, heptane, octane, isooctane), aromatic hydrocarbons (e.g. benzene, toluene, xylene), esters (e.g. ethyl, propyl, butyl or hexyl acetate), halogenated hydrocarbons (e.g. chlorobenzene), alkanols (e.g. methanol, ethanol, ethylene glycol, ethylene glycol monomethyl ether), and ethers (e.g. diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter the possible reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the acrylic PSAs without solvent. A particularly suitable technique for use in this case is the prepolymerization technique. Polymerization is initiated with UV light but taken only to a low conversion of about 10-30%. The resulting polymer syrup can then be welded for example, into films (in the simplest case, ice cubes) and then polymerized through to a high conversion in water. These pellets can subsequently be used as acrylic hotmelt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer block. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on Samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylic monomers, such as n-butyl acrylate and 2-ethylhexyl acrylate, for example, can be polymerized directly and do not have to be generated in the polymer by transesterification with the corresponding alcohol.

Methods suitable for preparing polyacrylate PSAs with a narrow molecular weight distribution also include controlled free radical polymerization methods. In that case it is preferred to use, for the polymerization, a control reagent of the general formula

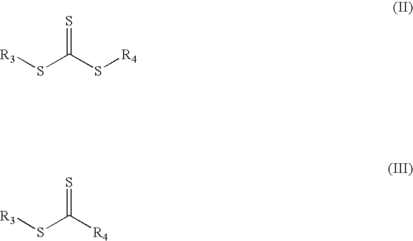

in which R₃ and R₄ independently of one another or identically are chosen from the following group:

branched and unbranched C₁ to C₁₈ alkyl radicals; C₃ to C₁₈ alkenyl radicals; C₃ to C₁₈ alkynyl radicals;

C, to C₁₋₈ alkoxy radicals;

C₃ to C₁₈ alkynyl radicals; C₃ to C₁₈ alkenyl radicals; C₁ to C₁₈ alkyl radicals substituted by at least one OH group or a halogen atom or a silyl ether;

C₂-C₁₈ heteroalkyl radicals having at least one O atom and/or one NR* group in the carbon chain, R* being any radical (particularly an organic radical);

C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;

C₃-C₁₂ cycloalkyl radicals;

C₆-C₁₈ aryl or benzyl radicals;

hydrogen.

Control reagents of type (II) are preferably composed of the following further-restricted compounds:

halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl. Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl. Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl. Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethylbenzene, toluene, xylene, mesitylene, isopropylbenzene, dichlorobenzene or bromotoluene.

The above enumerations serve only as examples of the respective groups of compounds, and make no claim to completeness.

Other compounds which can be used as control reagents include those of the following types:

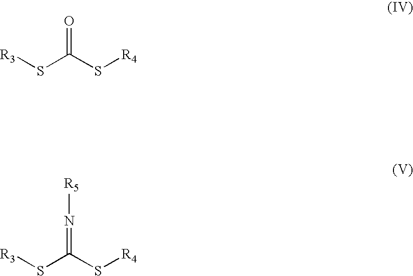

where R₅, again independently from R₃ and R₄, may be selected from the group recited above for these radicals.

In the case of the conventional ‘RAFT’ process polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing. In order to circumvent this disadvantage of low conversions, the polymerization in one particularly preferred procedure is initiated two or more times.

As a further controlled free radical polymerization method it is possible to carry out nitroxide-controlled polymerizations. For radical stabilization, in a favorable procedure, use is made of nitroxides of type (VI) or (VII):

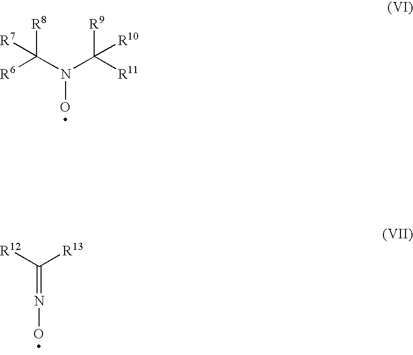

where R⁶, R⁷, R⁸, R⁹, R¹⁰, R¹¹, R¹², and R¹³ independently of one another denote the following compounds or atoms:

i) halides, such as chlorine, bromine or iodine, for example

ii) linear, branched, cyclic, and heterocyclic heterocarbons having 1 to 20 carbon atoms, which may be saturated, unsaturated or aromatic,

iii) esters —COOR¹⁴, alkoxides —OR¹⁵ and/or phosphonates —PO(OR¹⁶)₂,

where R¹⁴, R¹⁵ or R¹⁶ stand for radicals from group ii).

Compounds of type (VI) or (VII) can also be attached to polymer chains of any kind (primarily such that at least one of the abovementioned radicals constitutes a polymer chain of this kind) and may therefore be used for the synthesis of polyacrylate PSAs.

With greater preference, compounds of the following types are used as controlled regulators for the polymerization:

2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL

2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO,

2,2,6,6,-tetraethyl-1-piperidinyloxyl, 2,2,6-trimethyl-6-ethyl-1-piperidinyloxyl

N-tert-butyl 1-phenyl-2-methylpropyl nitroxide

N-tert-butyl 1-(2-naphthyl)-2-methylpropyl nitroxide

N-tert-butyl 1-diethylphosphono-2,2-dimethylpropyl nitroxide

N-tert-butyl 1-dibenzylphosphono-2,2-dimethylpropyl nitroxide

N-(1-phenyl-2-methylpropyl) 1-diethylphosphono-1-methylethyl nitroxide

di-t-butyl nitroxide

diphenyl nitroxide

t-butyl t-amyl nitroxide.

A series of further polymerization methods in accordance with which the PSAs can be prepared by an alternative procedure can be chosen from the prior art. U.S. Pat. No. 4,581,429 A discloses a controlled-growth free radical polymerization process which uses as its initiator a compound of the formula R′R″N—O—Y, in which Y is a free radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific radical compounds, such as phosphorus-containing nitroxides based on imidazoline, for example, are employed. WO 98/44008 A1 discloses specific nitroxyls based on morpholines, piperazinones, and piperazinediones. DE 199 49 352 A1 describes heterocyclic alkoxyamines as regulators in controlled growth free radical polymerizations. Corresponding further developments of the alkoxyamines or of the corresponding free nitroxides improve the efficiency for the preparation of polyacrylates (Hawker, paper to the National Meeting of the American Chemical Society, Spring 1997; Husemann, paper to the IUPAC World-Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in U.S. Pat. Nos. 5,945,491 A, 5,854,364 A and 5,789,487 A.

Coating Processes, Treatment of the Backing Material with the PSA

For the production of PSAs, the polymers described above are coated preferably as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Further processing of the hotmelt takes place from the melt.

Moreover, in one very preferred version, the chalk filler is added to the acrylic hotmelt in the melt. For homogeneous compounding into the melt it is preferred to employ a twin-screw extruder or a planetary roll extruder.

In the preferred process the hotmelt PSA is coated through an extrusion die. The extrusion dies used may advantageously originate from one of the following categories: T-dies, fishtail dies and coathanger dies. The individual types differ in the design of their flow channel. Through the form of the extrusion die it is likewise possible to minimize the orientation within the hotmelt PSA. Coating is carried out with particular preference onto a backing using a coathanger die, specifically such that a layer of polymer on the backing is formed by means of a movement of die relative to backing.

The time which elapses between coating and crosslinking is short. In one preferred procedure, crosslinking is carried out after less than 60 minutes, in another preferred procedure, after less than 3 minutes, and in a very preferred procedure, in an in-line process, after less than 10 seconds.

The backing material provided with the inventive hotmelt PSA can comprise a single-sided or double-sided adhesive tape.

In one version, transfer tapes are produced. Suitable backing material includes, for example, all siliconized or fluorinated films having a release effect. Film materials that may be mentioned here, given only by way of example, include BOPP, MOPP, PET, PVC, PU, PE, PE/EVA, EPDM, and PP. For transfer tapes it is also possible, furthermore, to use release papers (glassine papers, kraft papers, polyolefinically coated papers).

For optional UV crosslinking the PSA tape is exposed to short wave ultraviolet radiation in a wavelength range from 200 to 400 nm, depending on the UV photoinitiator used; irradiation is carried out in particular using high or medium pressure mercury lamps with an output of from 80 to 240 W/cm. The irradiation intensity is adapted to the respective quantum yield of the UV photoinitiator, the degree of crosslinking to be set, and the extent of the orientation.

In one greatly preferred crosslinking process the PSA is crosslinked using electron beams. Typical irradiation equipment which can be employed includes linear cathode systems, scanner systems, and segmented cathode systems, where electron beam accelerators are employed. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 to 150 kGy, in particular between 20 and 100 kGy.

It is also possible to employ both crosslinking processes, or other processes allowing high-energy irradiation.

Experiments

The invention is described below by experiments, without wishing to subject it to any unnecessary restriction through the choice of the specimens investigated.

The following test methods have been employed.

Measurement of the Shrinkback (Test A)

Strips with a width of at least 30 mm and a length of 20 cm were cut parallel to the coating direction of the hotmelt. At application rates of 100 g/m², 3 strips were laminated to one another. The specimen obtained in this way was then cut to a width of exactly 20 mm and was overstuck at each end with paper strips, with a spacing of 15 cm. The test specimen thus prepared was then suspended vertically at room temperature and the change in length was monitored over time until no further shrinkage of the sample could be found. The initial length reduced by the final value was then reported, relative to the initial length, as the shrinkback, in percent.

For measuring the orientation after a prolonged period, the coated and oriented PSAs were stored for a prolonged period in the form of swatches, and then analyzed. Among oriented pressure sensitive adhesives there is understood the tendency, after stretching in a given direction, to move back to the original state as a result of the so-called entropy-elastic behavior.

Gel Permeation Chromatography GPC (Test B)

The average molecular weight M_{w} and the polydispersity PD were determined by gel permeation chromatography. The eluent used was THF containing 0.1% by volume trifluoroacetic acid. Measurement was made at 25° C. The precolumn used was PSS-SDV, 5μ, 10³Π, ID 8.0 mm×50 mm. Separation was carried out using the columns PSS-SDV, 5μ, 10³ and 10⁵ and 10⁶Π each with ID 8.0 mm×300 mm. The sample concentration was 4 g/l, the flow rate 1.0 ml per minute. Measurement was made against PMMA standards.

180° Bond Strength Test (Test C)

A strip 20 mm wide of an acrylic PSA coated onto polyester or siliconized release paper was applied to steel plates (Test C1) or to PE plates (Test C2). The PSA strip was pressed onto the substrate twice using a 2 kg weight. The adhesive tape was then immediately peeled from the substrate at an angle of 180° and at 30 mm/min. The steel plates were washed twice with acetone and once with isopropanol. The PE plates used were new each time. The results are reported in N/cm and are averaged from three measurements. All measurements were carried out at room temperature under controlled-climate conditions.

Shear Strength (Test D)

A strip of the adhesive tape 13 mm wide was applied to a smooth steel surface which had been cleaned three times with acetone and once with isopropanol. The area of application was 20 mm×13 mm (length×width). The adhesive tape was then pressed onto the steel support four times with an applied pressure of 2 kg. The systems were subjected to loading at room temperature using a 1 kg weight. The shear stability times measured are reported in minutes and correspond to the average of three measurements.

Production of the Samples

Poltmer 1

A 200 L reactor conventional for free radical polymerizations was charged with 26 kg of methyl acrylate, 32 kg of 2-ethylhexyl acrylate, 32 kg of butyl acrylate and 53.3 kg of acetone/isopropanol (85:15). After nitrogen gas had been passed through the reactor for 45 minutes with stirring, the reactor was heated to 58° C. and 40 g of 2,2′-azoisobutyro-nitrile (AIBN) were added. The external heating bath was then heated to 75° C. and the reaction was carried out constantly at this external temperature. After 1 hour of reaction a further 40 g of AIBN were added. After 5 hours and 10 hours dilution was carried out with 15 kg of acetone/isopropanol (85:15) each time. After 6 hours and 8 hours 100 g of dicyclohexyl peroxydicarbonate (Perkadox 16®, Akzo Nobel) in solution in 800 g of acetone were added in each case. The reaction was terminated after 24 hours and the product cooled to room temperature. Determination of the molecular weight by Test B gave an M_{w} of 374 000 g/mol with a polydispersity M_{w}/Mₙ of 6.2.

Polymer 2

A 200 L reactor conventional for free radical polymerizations was charged with 26 kg of isobornyl acrylate, 32 kg of 2-ethylhexyl acrylate, 32 kg of butyl acrylate and 53.3 kg of acetone/isopropanol (85:15). After nitrogen gas had been passed through the reactor for 45 minutes with stirring, the reactor was heated to 58° C. and 40 g of 2,2′-azoisobutyro-nitrile (AIBN) were added. The external heating bath was then heated to 75° C. and the reaction was carried out constantly at this external temperature. After 1 hour of reaction a further 40 g of AIBN were added. After 5 hours and 10 hours dilution was carried out with 15 kg of acetone/special boiling point spirit 60/95 (50:50) each time. After 6 hours and 8 hours 100 g of dicyclohexyl peroxydicarbonate (Perkadox 16®, Akzo Nobel) in solution in 800 g of acetone were added in each case. The reaction was terminated after 24 hours and the product cooled to room temperature. Determination of the molecular weight by Test B gave an M_{w} of 394 000 g/mol with a polydispersity M_{w}/Mₙ of 6.5.

### REFERENCE EXAMPLE 1

Polymer 1 was blended in solution with 30% by weight of a C₅-C₉ HC resin from VFT Rüttgers (TK 90H) with 5% by weight of a phthalic ester (Palatinol™ AH, BASF AG) and 1% by weight of trifunctional acrylate (SR 444, Cray Valley) and the blend was subsequently freed from solvent under reduced pressure and at a temperature of 120° C.

### REFERENCE EXAMPLE 2

Polymer 2 was blended in solution with 30% by weight of a C₅-C₉ HC resin from VFT Rüttgers (TK 90H) with 5% by weight of a phthalic ester (Palatinol™ AH, BASF AG) and 1% by weight of trifunctional acrylate (SR 444, Cray Valley) and the blend was subsequently freed from solvent under reduced pressure and at a temperature of 120° C.

### EXAMPLE 3

Polymer 1 was blended in solution with 30% by weight of a C₅-C₉ HC resin from VFT Rüttgers (TK 90H), with 30% by weight of chalk (Mikrosohl), with 5% by weight of a phthalic ester (Palatinol™ AH, BASF AG) and 1% by weight of trifunctional acrylate (SR 444, Cray Valley) and the blend was subsequently freed from solvent under reduced pressure and at a temperature of 120° C.

### EXAMPLE 4

Polymer 2 was blended in solution with 30% by weight of a C₅-C₉ HC resin from VFT Rüttgers (TK 90H), with 30% by weight of chalk (Mikrosöhl), with 5% by weight of a phthalic ester (Palatinol™ AH, BASF AG) and 1% by weight of trifunctional acrylate (SR 444, Cray Valley) and the blend was subsequently freed from solvent under reduced pressure and at a temperature of 120° C.

i) Production of Specimens for Determining the Shrinkback

Examples 1 to 4 were coated through a coathanger extrusion die with a die gap of 300 μm and a coating width of 33 cm at 170° C. (melt temperature) with a web speed of 10 m/min onto a 12 μm PET film coated with 1.5 g/m² of silicone (polydimethylsiloxane). At an application rate of 100 g/m² (corresponding to a PSA film approximately 100 μm thick) a draw ratio of 3:1 was set.

The siliconized PET film was passed over a steel roller rotating in the same direction, which was heated at 60° C. Then, in an in-line process, after a section of about 5 m, the PSA tape was crosslinked using electron beams. Electron beam crosslinking was carried out using an instrument from the company Electron Crosslinking AB, Halmstad, Sweden. The coated PSA tape was passed over a chill roll, which is a standard feature, beneath the Lenard window of the accelerator. In the zone of irradiation the atmospheric oxygen was displaced by flushing the pure nitrogen. The web speed was in each case 10 m/min.

Irradiation was carried out through the tape with an acceleration voltage of 180 kV and with a dose of 80 kGy (kilograys).

The shrinkback was determined by carrying out Test A.

Results

In a first investigation the degree of orientation of the individual PSAs of Examples 1 to 4 was determined after coating. This was done by determining the shrinkback in the free film in accordance with test method A, the values found are compiled in table 1.

TABLE 1
Overview of shrinkback values found in the free film (Test A).

| Example | Shrinkback in the free film (Test A) |
|---|---|
| Reference example 1 | 7% |
| Reference example 2 | 6% |
| Example 3 | 2% |
| Example 4 | 2% |

The reference examples 1 and 2 in table 1 exhibit a more pronounced resilience (shrinkback) than the inventive examples 3 and 4. Through the addition of the Mikrosöhl chalk there is a distinct reduction in the resilience.

In table 2 below, the technical adhesive data for all examples, 1 to 4, were determined. The procedure was along the lines of test methods C and D.

TABLE 2
Overview of the technical adhesive properties found

| | Bond strength | Bond strength | |
|---|---|---|---|
| | on steel | on PE | Shear stability |
| Example | (Test C1) | (Test C2) | times (Test D) |
| Reference example 1 | 11.2 N/cm | 4.0 N/cm | 1860 min |
| Reference example 2 | 12.5 N/cm | 3.2 N/cm | 3420 min |
| Example 3 | 11.4 N/cm | 4.1 N/cm | 2015 min |
| Example 4 | 12.4 N/cm | 3.4 N/cm | 3405 min |

Application rate: 50 g/m²

A comparison of the bond strengths of reference examples 1 and 2 with the inventive examples 3 and 4, respectively, shows that for the comparable pairings virtually the same technical adhesive properties were measured. The differences are situated within the bounds of the inaccuracy of the test measurement method.

By adding chalk and avoiding carboxyl- or hydroxyl-containing comonomers it was therefore possible to retain both the shrinkback capacity and the technical adhesive properties. Moreover, as a result of the chalk filler, a distinct reduction was achieved in the production costs of the acrylic hotmelt PSA as well.

1. A hotmelt pressure sensitive adhesive comprising at least one polyacrylate component and an added filler comprising carbonate, wherein said at least one polyacrylate component
is formed from monomers comprising least 50% by weight, of at least one acrylic or methacrylic ester, or both, of the formula (I)
Ch₂═CH(R₁)(COOR₂) (i)
where R₁═H or CH₃ and R₂ is an unbranched, branched or cyclic alkyl radical having 1 to 22 carbon atoms and
is substantially free from polar groups.

2. The adhesive as claimed in claim 1, wherein said at least one polyacrylate component has an average molar weight M_{w} of not more than 500 000 g/mol.

3. The adhesive as claimed in claim 1, wherein the added filler comprising calcium carbonate is chalk.

4. The adhesive as claimed in claim 1, wherein the amount of said added filler comprising calcium carbonate at least 10% wt., based on the weight of polyacrylate component.

5. The adhesive as claimed in claim 1, having a shrinkback, after extrusion coatings of not more than 5%.

6. The adhesive as claimed in claim 1, wherein said at least one polyacrylate component is substantially free of carboxyl or hydroxyl groups.

7. The adhesive as claimed in claim 1, wherein R₂ is selected from the group consisting of unbranched, branched, and cyclic C₄ to C₁₄ alkyl radicals.

8. The adhesive as claimed in claim 7, wherein R₂ is selected from the group consisting of bridged or unbridged, alkylated or unalkylated cycloalkyl radicals having at least 6 carbon atoms.

9. The adhesive as claimed in of claim 7, wherein the at least one acrylic and/or methacrylic ester of formula (I) is selected from the group consisting of methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, isobutyl acrylate, 2-ethylhexyl acrylate, 2-ethylhexyl methacrylate, isooctyl acrylate, isooctyl methacrylate, cyclohexyl methacrylate, isobornyl acrylate, isobornyl methacrylate, and 3,5-dimethyladamantyl acrylate.

10. The adhesive as claimed in claim 1 wherein said monomers further comprise at least one comonomer in addition to said at least one acrylic and/or methacrylic ester.

11. The adhesive as claimed in claim 10, wherein the at least one comonomer is a compound selected from the group consisting of alkyl-substituted amides.

12. The adhesive as claimed in claim 10, wherein the at least one comonomer is a compound selected from the group containing maleic anhydride, itaconic anhydride, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, and tetrahydrofurfuryl acrylate.

13. The adhesive as claimed in claim 10, wherein the at least one comonomer is a compound selected from the group consisting of vinyl esters, vinyl ethers, vinyl halides, vinylidene halides, vinyl compounds having aromatic rings or heterocycles in α-position, especially containing vinyl acetate, vinyl formamide, vinyl pyridine, ethyl vinyl ether, vinyl chloride, vinylidene chloride, and acrylonitrile.

14. The adhesive as claimed in claim 10, wherein the at least one comonomer is a photoinitiator having a copolymerizable double bond.

15. The adhesive as claimed in claim 10, wherein at least one vinyl aromatic compound is added to the at least one comonomer.

16. The adhesive as claimed in claim 1, further comprising at least one resin component in selected from the group consisting of pinene resins, indene resins, and rosins, and their derivatives and salts; aliphatic, aromatic and alkylaromatic hydrocarbon resins, hydrogenated hydrocarbon resins; substituted oF and unsubstituted hydrocarbon resins, natural resins, terpene resins, and terpene-phenolic resins.

17. The adhesive as claimed in claim 1, further comprising one or more additives selected from the group consisting of plasticizers, nucleators, expandants, compounding agents, aging inhibitors, crosslinkers and promoters.

18. A process for preparing the hotmelt pressure sensitive adhesive of claim 1, which comprises
(a) at least partially of polymerizing at least one acrylic and/or methacrylic ester of the formula (I)
CH₂═CH(R₁)(COOR₂) (I)
where R₁ is H or CH₃ and R₂ is an unbranched, branched or cyclic C₁ to C₂₂ alkyl radical, optionally in the presence of at least one comonomer, to prepare a polyacrylate component, and
(b) adding a filler comprising calcium carbonate to the polymerization media before or after the polymerization.

19. The process as claimed in claim 18, wherein the polymerization is conducted in solution or without solvent.

20. The process as claimed in claim 18 or 19, wherein the polymerization is conducted in the presence of at least one control reagent of the formula (II), (III), (IV) and/or (V) 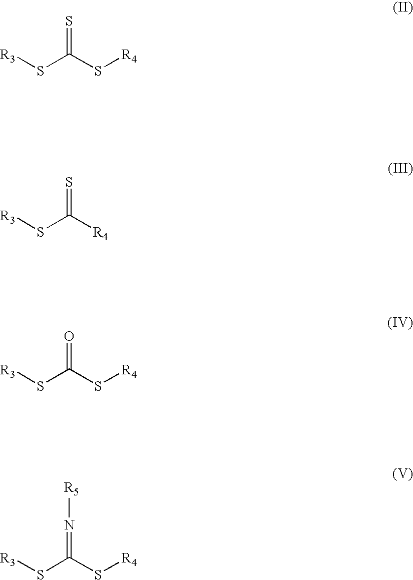
in which R₃, R₄, and R₅ independently of one another or identically are selected from the group consisting of
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one O atom and/or one NR* group in the carbon chain, R* being an organic radical;
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

21. The process as claimed in claim 18 or 19, wherein the polymerization is conducted in the presence of at least one control reagent of the general formula (VI) and/or (VII) 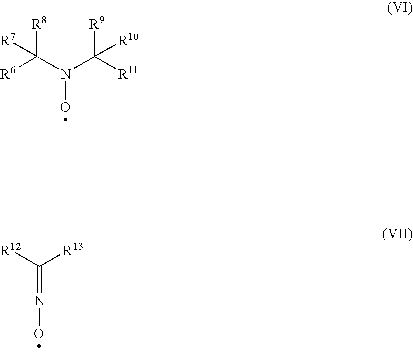
where R⁶, R⁷, R⁸, R⁹, R¹⁰, R¹¹, R¹², and R¹³ independently of one another denote:
i) halides,
ii) linear, branched, cyclic, and heterocyclic heterocarbons having 1 to 20 carbon atoms, which are optionally saturated, unsaturated or aromatic,
iii) esters —COOR¹⁴, alkoxides —OR¹⁵ and/or phosphonates —PO(OR¹⁶)₂,
where R¹⁴, R¹⁵ or R¹⁶ stand for radicals from group ii).

22. A pressure sensitive adhesive tape comprising a backing material which is impregnated by a flame retardant and coated on one or both sides with the adhesive of claim 1.

23. The pressure-sensitive adhesive tape as claimed in claim 22, wherein the backing material used is a nonwoven, a woven-nonwoven composite or a woven fabric.

24. The pressure-sensitive adhesive tape as claimed in claim 22 or 23, wherein the backing material is coated with the hotmelt pressure sensitive adhesive from the melt by a hotmelt process.

25. The pressure-sensitive adhesive tape as claimed in claim 22 or 23, wherein following its application to the backing material the hotmelt pressure sensitive adhesive is crosslinked.

26. The pressure-sensitive adhesive tape of claim 24, wherein said hotmelt process is roll coating, a melt die process or extrusion coating.

27. The pressure-sensitive adhesive tape of claim 25, wherein said crosslinking is by UV irradiation, electron beam irradiation, another form of high-energy irradiation, or any combination thereof.

28. The pressure-sensitive adhesive tape of claim 14, wherein said photoinitiator having a copolymerizable double bond is selected from the group consisting of Norrish I and Norrish II photoinitiators, benzoin acrylates and acrylated benzophenones.

29. The pressure-sensitive adhesive tape of claim 25, wherein said adhesive is crosslinked by UV radiation and/or electron beams and/or any other high-energy irradiation
